(19) United States
(12) Patent Application Publication
(10) Pub. No.: US 2026/0228763 A1
(43) Pub. Date: Aug. 6, 2026

(54) Behavior-Based Verifiable Completion Evidence Generation and Third-Party Auditable Evidence Output

(71) Applicant: Yitongxi Ltd., Taipei (TW)

(72) Inventor: Tingwei Ku, Taipei (TW)

(21) Appl. No.: 19/632,041

(22) Filed: Mar. 27, 2026

(51) Int. Cl. G06Q 30/0201

(52) U.S. Cl. CPC G06Q 30/02011

(57) ABSTRACT

A computer-implemented method and system generate third-party verifiable completion evidence from user behavior. Behavior evidence is received and compared with a task completion-condition set. A verifiability threshold including at least one of a time condition, a frequency condition, or a risk condition is evaluated. When satisfied, an irreversible completion-state marker is generated. One or more events are appended to an append-only behavior timeline to form an auditable event sequence. An evidence package and a readable report are output and linked via a common evidence identifier to enable third-party auditing and consistency checks.

### TECHNICAL FIELD

The present disclosure relates to computer-implemented verification and auditability techniques, and more particularly to generating irreversible task-completion evidence from user behavior and outputting an evidence package and a readable report that are auditable by a third party.

### BACKGROUND

Many digital services rely on incentives, missions, advertising interactions, and engagement metrics. However, conventional platforms often treat advertising, rewards, education/compliance, and reporting as separate silos. As a result, it is difficult for a relying party (e.g., an auditor, a financial institution, or an ESG governance function) to determine whether a reported completion or engagement event is attributable to real user behavior, satisfies defined conditions, and remains tamper-resistant over time. Existing evidence packaging, timestamping, digital signing, and attestation approaches tend to focus on integrity of a file or a device state, rather than on an auditable chain of task completion determined by a condition set and governed over time.

### SUMMARY

In various embodiments, a processing device receives behavioral evidence associated with a user, obtains a completion-condition set for a task, and compares the evidence with the condition set. A verifiability threshold including one or more of a time condition, a frequency condition, or a risk condition is evaluated. When the threshold is satisfied, an irreversible completion-state marker is generated. Events are appended (without modification to prior events) to an append-only behavior timeline to form an auditable event sequence. An evidence package and a readable report are output and linked by a common evidence identifier (Evidence ID), enabling third-party auditing and consistency checking.

The disclosed techniques can support governance scenarios such as ESG reporting, compliance validation, reward redemption, donation/tax workflows, and other contexts requiring traceable and auditable completion evidence.

### BRIEF DESCRIPTION OF THE DRAWINGS

FIG. 1 is a block diagram of an example system architecture for verifiable completion evidence generation and third-party auditable evidence output.

FIG. 2 is a flow diagram illustrating an example method for generating an irreversible completion marker and outputting a linked evidence package and readable report.

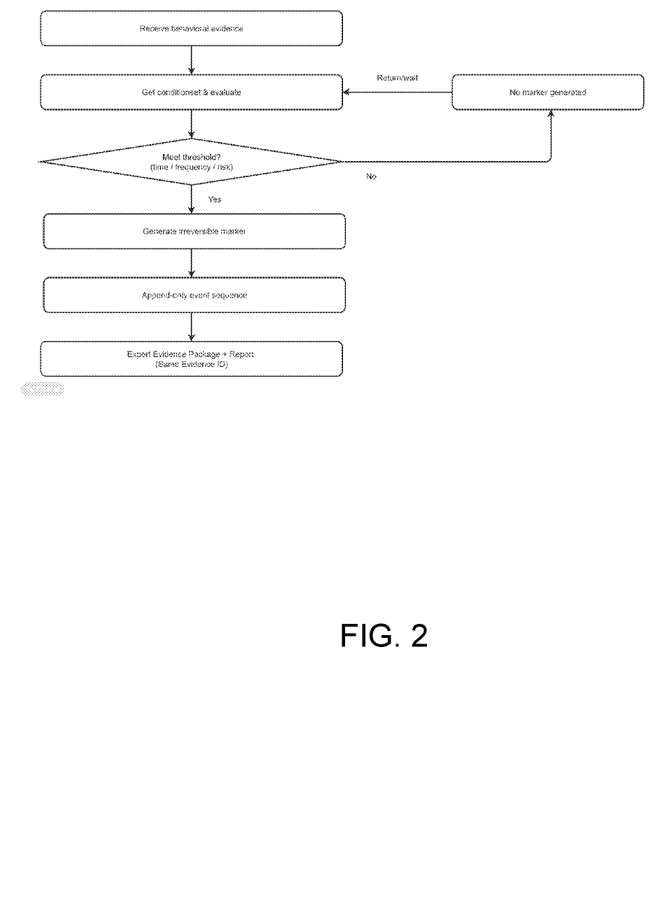

FIG. 3 illustrates Evidence ID mapping between an evidence package and a readable report, including a minimum field set and an example consistency check.

FIG. 4 illustrates an append-only behavior timeline with events and optional governance events appended to indicate changes in effect without modifying the irreversible marker.

FIG. 5 illustrates example output trigger mechanisms, including completion-event triggers, batch scheduling, and abnormal-event triggers that may delay or pause output.

### DETAILED DESCRIPTION

The following description is presented to enable a person of ordinary skill in the art to make and use the disclosed embodiments. Various modifications, alternatives, and equivalents will be apparent, and the disclosed principles may be applied to other embodiments without departing from the scope of the claims. Accordingly, the disclosure is not limited to the embodiments described, but is to be accorded the broadest scope consistent with the principles and features described herein.

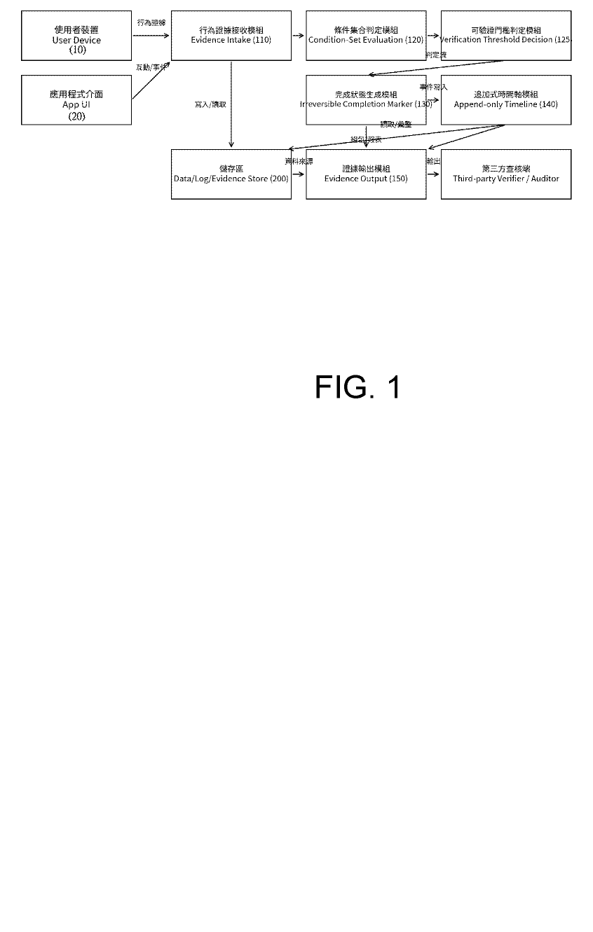

### SYSTEM OVERVIEW (FIG. 1)

Referring to FIG. 1, a system 100 may include a user device 10 executing an application interface (App UI) 20. The App UI 20 may collect or mediate user interactions that constitute behavioral evidence, such as task participation, confirmations, submissions, content views, clicks, in-app actions, device signals, or other observable events.

The system 100 may include: an evidence intake module 110 to receive behavioral evidence; a condition-set evaluation module 120 to obtain a completion-condition set for a task and evaluate the evidence against the condition set; a verification threshold decision module 125 to determine whether a verifiability threshold is met; an irreversible completion marker module 130 to generate an irreversible completion-state marker when the threshold is met; an append-only timeline module 140 to append events to a behavior timeline; and an evidence output module 150 to output an evidence package and a readable report that share a common Evidence ID. A data store 200 (e.g., log store, evidence store, or immutable store) may store evidence records, condition sets, markers, events, and output artifacts.

A third-party verifier or auditor 300 may receive the evidence package and/or access it through an interface, and may use the Evidence ID to check consistency between the evidence package and the readable report. In some embodiments, the evidence output module 150 may provide a link, token, or API endpoint for third-party access, subject to authorization controls.

### BEHAVIOR EVIDENCE AND CONDITION SETS

Behavioral evidence may include, without limitation: user input events, application events, device telemetry, session identifiers, network metadata, content interaction records, reward redemption requests, donation-related confirmations, or other signals. In some embodiments, behavioral evidence is normalized into one or more evidence records, each record including at least an evidence type, timestamp, and a user/session association.

A completion-condition set for a task may include multiple conditions that must be satisfied to deem the task completed. Example conditions include: (i) a minimum or maximum time window between events; (ii) a minimum frequency or count of occurrences; (iii) a risk-related condition such as anomaly scores, device consistency checks, or policy rules; and (iv) content-related conditions such as completion of a required education or disclosure step.

### VERIFIABILITY THRESHOLD AND IRREVERSIBLE MARKER

The verification threshold decision module 125 may evaluate a verifiability threshold that includes one or more of a time condition, frequency condition, and risk condition. For example, a task may require that a user perform a set of actions across multiple sessions over at least N days, that the frequency of a given action does not exceed a rate limit, and that risk indicators remain below a threshold. The verifiability threshold may be expressed as rules, constraints, or a scoring function.

When the verifiability threshold is satisfied, the irreversible completion marker module 130 generates an irreversible completion-state marker. In various embodiments, the marker is immutable once created, and serves as a durable representation that the task reached a completed state under the evaluated rules. The marker may include, for example, a marker identifier, a task identifier, a user identifier (or a privacy-preserving reference), a creation time, and a hash of selected summary fields.

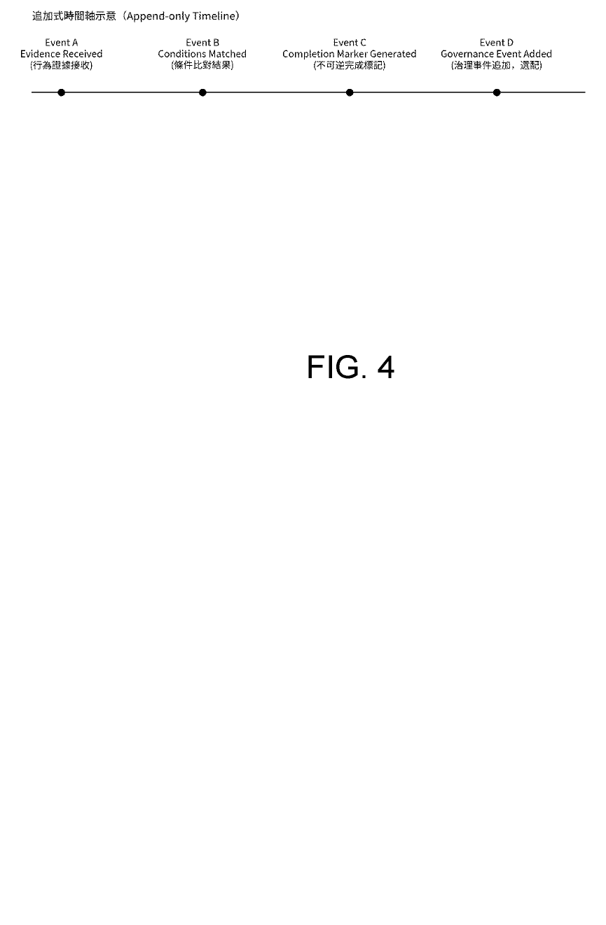

### APPEND-ONLY TIMELINE AND GOVERNANCE EVENTS (FIG. 4)

The append-only timeline module 140 appends events to a behavior timeline to form an auditable event sequence. Each event may include an event type, timestamp, related identifiers (e.g., task ID, Evidence ID), and optional summaries or references to stored evidence records. Because the timeline is append-only, previously recorded events are not modified or deleted; instead, subsequent events are appended to represent later determinations or changes.

In some embodiments, governance events may be appended after a completion marker is created to reflect changes in effect without modifying the marker itself. Governance events may include, for example, revocation, downgrade, restriction, manual review outcomes, expiration, or consistency-check results. Accordingly, the system can preserve the original irreversible completion marker while providing an auditable record of subsequent governance actions.

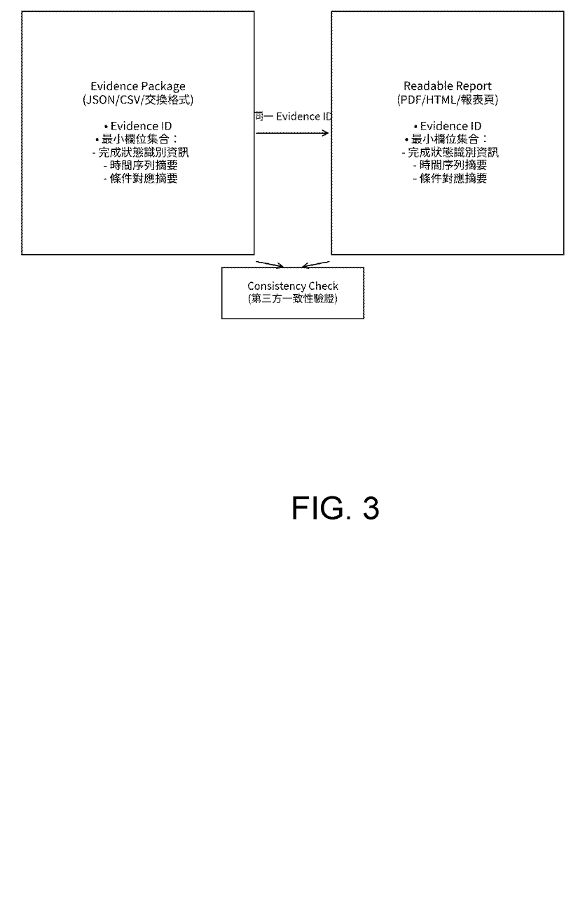

### EVIDENCE PACKAGE, READABLE REPORT, AND EVIDENCE ID MAPPING (FIG. 3)

The evidence output module 150 outputs (i) an evidence package and (ii) a readable report. The evidence package may be in a data interchange format such as JSON, XML, or CSV, and may include structured fields for machine processing. The readable report may be a PDF, HTML page, or report view designed for human review.

The evidence package and readable report share a common Evidence ID. In some embodiments, each contains the Evidence ID of the other or a mutual reference that permits a verifier to confirm consistency. A minimum field set may be included in the evidence package, such as: (1) completion-state identification information; (2) a time-series summary; and (3) a condition-correspondence summary. The readable report may be generated from the minimum field set and/or references to underlying evidence records, and may display the Evidence ID, the completion state, and relevant summaries for auditing.

### EXAMPLE DATA STRUCTURES (NON-LIMITING)

Example evidence package fields (illustrative):

EvidenceID: unique identifier linking package and report

TaskID, UserRef, MarkerID, MarkerCreatedAt

TimeSeriesSummary: e.g., event counts by period, key timestamps

ConditionCorrespondenceSummary: which conditions satisfied and how

RiskSummary: anomaly indicators, rate-limit results (optional)

TimelineRef: pointer(s) to append-only event sequence entries

GovernanceSummary: appended governance events (optional)

Example readable report sections (illustrative):

Evidence ID and task overview

Completion status and marker summary

Key timestamps and frequency statistics

Condition satisfaction table (time/frequency/risk)

Governance events and current effect (if any)

Verification or consistency-check result (if performed)

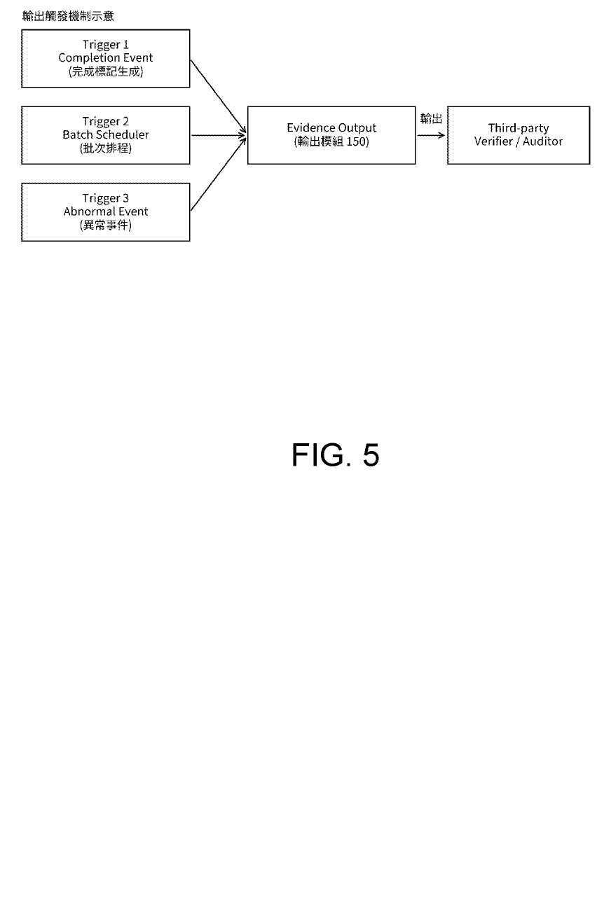

### OUTPUT TRIGGERS AND ABNORMAL HANDLING (FIG. 5)

Output of the evidence package and readable report may be triggered by a completion event (e.g., marker generation), by batch scheduling, or by detection of an abnormal event. In some embodiments, an abnormal event may cause the system to delay or pause marker generation and/or output while additional checks are performed. The abnormal event may be appended to the timeline as an auditable record, and may influence later governance actions or confidence scoring.

### IMPLEMENTATION NOTES

The disclosed modules may be implemented in hardware, software, firmware, or a combination thereof. For example, one or more modules may execute on a server, cloud platform, edge device, or distributed architecture. Data stores may employ tamper-evident logs, write-once storage, cryptographic chaining, or other mechanisms to support append-only properties, although such mechanisms are optional and may vary by embodiment.

1. A computer-implemented method for generating third-party auditable completion evidence from user behavior, the method comprising:
receiving, by a processing device, at least one behavioral evidence item associated with a user;
obtaining a completion-condition set for a task and comparing the at least one behavioral evidence item with the completion-condition set;
determining, based on the comparing, whether a verifiability threshold is satisfied, wherein the verifiability threshold comprises at least one of a time condition, a frequency condition, or a risk condition;
responsive to determining that the verifiability threshold is satisfied, generating an irreversible completion-state marker;
appending at least one event to an append-only behavior timeline to form an auditable event sequence, wherein the at least one event comprises the irreversible completion-state marker or condition-correspondence information associated therewith; and
outputting an evidence package and a readable report and linking the evidence package and the readable report with a common evidence identifier to enable third-party auditing.

2. The method of claim 1, wherein the evidence package and the readable report each include the common evidence identifier and mutually reference one another to enable a consistency check.

3. The method of claim 1, wherein the evidence package includes a minimum field set comprising: completion-state identification information, a time-series summary, and a condition-correspondence summary.

4. The method of claim 3, wherein the readable report is generated from the minimum field set and displays the common evidence identifier with a completion-state summary.

5. The method of claim 1, wherein the outputting is triggered by a marker generation event.

6. The method of claim 1, wherein the outputting is triggered by at least one of a batch schedule or an abnormal-event detection.

7. The method of claim 1, wherein the irreversible completion-state marker, once generated, is not modified or deleted.

8. The method of claim 7, further comprising representing an update of task effect by appending a governance event to the append-only behavior timeline without modifying the irreversible completion-state marker.

9. The method of claim 8, wherein the governance event comprises at least one of revocation, restriction, downgrade, manual review, expiration, or a consistency-check result.

10. The method of claim 1, further comprising, upon detecting an abnormal behavior or an unmet additional condition, delaying or pausing generation of the irreversible completion-state marker.

11. The method of claim 1, further comprising computing a confidence level based on at least one of the risk condition, the frequency condition, or a governance event, and including the confidence level in at least one of the evidence package or the readable report.

12. A system for generating third-party auditable completion evidence from user behavior, comprising:
an evidence intake module configured to receive at least one behavioral evidence item associated with a user;
a condition-set evaluation module configured to obtain a completion-condition set for a task and compare the at least one behavioral evidence item with the completion-condition set;
a verification threshold decision module configured to determine whether a verifiability threshold is satisfied, wherein the verifiability threshold comprises at least one of a time condition, a frequency condition, or a risk condition;
an irreversible completion marker module configured to, responsive to satisfaction of the verifiability threshold, generate an irreversible completion-state marker;
an append-only timeline module configured to append events to an append-only behavior timeline to form an auditable event sequence; and
an evidence output module configured to output an evidence package and a readable report and link the evidence package and the readable report with a common evidence identifier to enable third-party auditing.

13. The system of claim 12, wherein the evidence output module is further configured to embed the common evidence identifier in both the evidence package and the readable report.

14. A non-transitory computer-readable medium storing instructions that, when executed by one or more processors, cause the one or more processors to perform the method of claim 1.
